(19) United States
(12) Patent Application Publication
(10) Pub. No.: US 2023/0085425 A1
(43) Pub. Date: Mar. 16, 2023

(54) L1-SINR MEASUREMENT PROCEDURE BASED ON MEASUREMENT RESTRICTIONS

(71) Applicant: Telefonaktiebolaget LM Ericsson (publ), Stockholm (SE)

(72) Inventors: Kazuyoshi UESAKA, Kawasaki (JP); Muhammad Ali KAZMI, Sundbyberg (SE); Santhan THANGARASA, Vällingby (SE)

(21) Appl. No.: 17/794,664

(22) PCT Filed: Feb. 9, 2021
(86) PCT No.: PCT/SE2021/050094

§ 371 Date: Jul. 22, 2022

Related U.S. Application Data
(60) Provisional application No. 62/972,970, filed on Feb. 11, 2020.

(51) Int. Cl. H04W 24/10; H04B 17/336

(52) U.S. Cl. CPC H04W 24/10; H04B 17/336

(57) ABSTRACT

A method, system and apparatus are disclosed for L 1-SINR measurement procedure based on measurement restrictions. In one embodiment, a wireless device (WD) is configured to determine a number of samples for a Layer 1 signal-to-interference-p lus-noise ratio, L1-SINR, measurement, the number of samples being based at least in part on at least one measurement restriction parameter; determine a measurement period for the L 1 -SINR measurement based at least in part on the determined number of samples; and perform the L1-SINR measurement on at least one channel measurement resource and at least one interference measurement resource, the L1-SINR measurement being based at least in part on the determined number of samples and the measurement period. In one embodiment, a network node is configured to send a configuration comprising at least one measurement restriction parameter to the WD, the measurement restriction parameter associated with a L1-SINR measurement.

### TECHNICAL FIELD

The present disclosure relates to wireless communications, and in particular, to Layer 1 (L1) signal-to-interference-plus-noise ratio (SINR) measurement procedure based on measurement restrictions.

### BACKGROUND

### CSI Reporting

Channel State Information (CSI) reporting is an Open Systems Interconnection (OSI) Layer 1 (hereinafter “L1”) procedure to report the channel state information (CSI) from a wireless device (WD) such as, for example, a user equipment (UE) to the network, e.g., to a network node. In Third Generation Partnership Project (3GPP) Release 15 (Rel-15) New Radio (NR), CSI includes Channel Quality Indicator (CQI), precoding matrix indicator (PMI), CSI reference signal (CSI-RS) resource indicator (CRI), synchronization signal/physical broadcast channel (SS/PBCH) Block Resource indicator (SSBRI), layer indicator (LI), rank indicator (RI) and L1 reference signal received power (L1-RSRP). There are three types of CSI reporting configurations: periodic reporting, aperiodic reporting, and semi-persistent reporting. When the network (e.g., network node) configures the periodic CSI reporting, the WD reports the CSI periodically based on the reporting period (Tᵣₑₚₒᵣₜ) configured by the network node. When the network node configures the aperiodic CSI reporting, the WD only reports CSI once when the CSI is requested. When the network node configures the semi-persistent CSI reporting, the WD reports CSI periodically based on the reporting period (Tᵣₑₚₒᵣₜ) when the network node requests to start the reporting, and the WD stops reporting the CSI when the network node requests stoppage of the reporting.

### L1-SINR

It has been considered in 3GPP to introduce another CSI called “L1-SINR” in Release 16 (Rel-16). L1-SINR is the value of signal-to-interference-plus-noise-ratio (SINR), and the WD estimates L1-SINR based on the channel measurement resources (CMRs) and interference measurement resources (IMRs).

CMR are the resources used for channel power estimation. Examples of CMR include the synchronization signal block (SSB) and/or non-zero power CSI-RS (NZP-CSI-RS). CMR is scheduled every CMR transmission periodicity (referred to as TCMR). Examples of TCMR includes 20 millisecond (ms) or 40 ms or 20 slots or 40 slots. For every CMR transmission occasion, CMR symbols are transmitted in the frequency domain. For example, CMR symbols are transmitted in every 3 subcarriers in the frequency domain within the whole system bandwidth. Another example of CMR transmission in the frequency domain is 127 consecutive subcarriers in a certain block within the system bandwidth.

IMR are the resources used for interference and noise estimation. Examples of IMR include NZP-CSI-RS and/or zero power CSI-RS (ZP-CSI-RS). Like CMR, IMR is scheduled every T_{IMR}, and T_{IMR} is the IMR transmission periodicity. Examples of T_{CMR} include 20 ms or 40 ms or 20 slots or 40 slots. For every IMR transmission occasion, IMR symbols are transmitted in the frequency domain. For example, IMR symbols are transmitted in every 3 subcarriers in the frequency domain within the whole system bandwidth.

When the WD performs a L1-SINR measurement, the WD estimates L1-SINR based on the recent M_{CMR} transmission occasions in the time domain for CMR and recent M_{IMR} transmission occasions in time domain for IMR:

$$\text{L1\_SINR} \text{=} \frac{\text{P}}{I}$$

Where P is the power of channel measurement resources and I is the interference estimation derived from the interference measurement resources. Examples of P and I are given below as follows:

$$\begin{matrix}\text{P} \text{=} \frac{1}{{M}_{C M R}} {\sum }_{m = 1}^{{M}_{C M R}} \frac{1}{{N}_{C M R} \left(m\right)} {\sum }_{k = 1}^{{N}_{C M R} \left(m\right)} {\left|s \left(m , k\right)\right|}^{2} \\ \text{I} \text{=} \frac{1}{{M}_{I M R}} {\sum }_{m = 1}^{{M}_{C M R}} \frac{1}{{N}_{I M R} \left(m\right)} {\sum }_{k = 1}^{{N}_{I M R} \left(m\right)} {\left|n \left(m , k\right)\right|}^{2}\end{matrix}$$

Where s(m. k) is the channel measurement sample at frequency k and transmission time m, and n(m. k) is the interference measurement sample at frequency k and transmission time m. N_{CMR}(m) is the number of channel measurement symbols at the channel measurement sample transmission time m. N_{IMR}(m) is the number of interference measurement sample at the interference measurement sample transmission m.

FIG. 1 illustrates an example of CMR and IMR transmission, where CMR and IMR are transmitted every T_{CMR} slots and T_{IMR} slots, respectively. In this example, the WD estimates L1-SINR based on M_{CMR} (=3) CMR transmission occasions and M_{IMR} (=4) IMR transmission occasions.

### Measurement Period

Measurement is performed by the WD over a measurement period, which is a time period that satisfies a certain measurement accuracy. In the case of L1-RSRP, for example, the measurement period is given as a function of M_{CMR}, T_{CMR}, and Tᵣₑₚₒᵣₜ, and the measurement period is given by max(Tᵣₑₚₒᵣₜ, M_{CMR} * T_{CMR}). For example, M_{CMR} = 3 if the network does not configure the channel measurement restriction and M_{CMR} = 1 if the network configures the channel measurement restriction.

### SUMMARY

Some embodiments advantageously provide methods, systems, and apparatuses for OSI L1 SINR measurement procedure based on measurement restrictions.

In one embodiment, a method implemented in a network node includes configuring the WD with at least one measurement restriction parameter associated with an Open Systems Interconnection (OSI) Layer 1 (L1) signal-to-interference-plus-noise ratio (SINR) measurement; and receiving, from the WD, an L1 SINR report based at least in part on an L1 SINR measurement on channel measurement resources and interference measurement resources, the L1 SINR measurement based at least in part on a first number of samples, M_{CMR}, for channel measurement and a second number of samples, M_{IMR}, for interference measurement and at least one measurement period, the first and second numbers of samples being based at least in part on the at least one measurement restriction parameter and the at least one measurement period based at least in part on the first and second numbers of samples.

In one embodiment, a method implemented in a wireless device (WD) includes determining a first number of samples, M_{CMR}, for channel measurement and a second number of samples, M_{IMR}, for interference measurement for an Open Systems Interconnection (OSI) Layer 1 (L1) signal-to-interference-plus-noise ratio (SINR) measurement, the first and second numbers of samples being based at least in part on at least one measurement restriction parameter; determining at least one measurement period based at least in part on the first and second numbers of samples; and performing the L1 SINR measurement on channel measurement resources and interference measurement resources based at least in part on the determined numbers of samples and the at least one measurement period.

According to an aspect of the present disclosure, a method implemented in a wireless device, WD, is provided. The method includes determining a number of samples for a Layer 1 signal-to-interference-plus-noise ratio, L1-SINR, measurement, the number of samples being based at least in part on at least one measurement restriction parameter. The method includes determining a measurement period for the L1-SINR measurement based at least in part on the determined number of samples. The method includes performing the L1-SINR measurement on at least one channel measurement resource and at least one interference measurement resource, the L1-SINR measurement being based at least in part on the determined number of samples and the measurement period.

In some embodiments of this aspect, determining the number of samples based at least in part on the at least one measurement restriction parameter comprises: when the at least one measurement restriction parameter indicates a restriction on at least one of a channel measurement and an interference measurement, determining that the number of samples is 1. In some embodiments of this aspect, determining the number of samples based at least in part on the at least one measurement restriction parameter comprises: when the at least one measurement restriction parameter indicates that there is a lack of a restriction on any of the channel measurement and the interference measurement, determining that the numbers of samples is greater than 1.

In some embodiments of this aspect, determining the number of samples based at least in part on the at least one measurement restriction parameter comprises: when the at least one measurement restriction parameter indicates that there is a lack of a restriction on any of the channel measurement and the interference measurement, determining that the numbers of samples is 3. In some embodiments of this aspect, the method further includes receiving a configuration including the at least one measurement restriction parameter. In some embodiments of this aspect, the at least one measurement restriction parameter comprises at least one of a time restriction for channel measurement and a time restriction for interference measurement.

In some embodiments of this aspect, determining the number of samples based at least in part on the at least one measurement restriction parameter comprises: when at least one of the channel measurement restriction and the interference measurement restriction is configured to the WD, determining that the number of samples is 1, otherwise; determining that the numbers of samples is greater than 1. In some embodiments of this aspect, determining the measurement period for the L1-SINR measurement further comprises determining the measurement period as a function of at least one of: the determined number of samples, a transmission period of the at least one channel measurement resource in time domain, a transmission period of the at least one interference measurement resource in time domain, an L1-SINR reporting period, and a scaling factor.

According to yet another aspect of the present disclosure, a method implemented in a network node configured to communicate with a wireless device, WD, is provided. The method comprises sending a configuration comprising at least one measurement restriction parameter to the WD, the at least one measurement restriction parameter associated with a Layer 1 signal-to-interference-plus-noise ratio, L1-SINR, measurement. The method comprises receiving an L1-SINR report from the WD, the L1-SINR report being based at least in part on an L1 SINR measurement on at least one channel measurement resource and at least one interference measurement resource over a measurement period, the measurement period being based at least in part on a number of samples, the number of samples being based at least in part on the at least one measurement restriction parameter.

In some embodiments of this aspect, when the at least one measurement restriction parameter indicates a restriction on at least one of a channel measurement and an interference measurement, the number of samples is 1. In some embodiments of this aspect, when the at least one measurement restriction parameter indicates that there is a lack of a restriction on any of the channel measurement and the interference measurement, the numbers of samples is 3. In some embodiments of this aspect, when the at least one measurement restriction parameter indicates that there is a lack of a restriction on any of the channel measurement and the interference measurement, the numbers of samples is greater than 1.

In some embodiments of this aspect, the at least one measurement restriction parameter comprises at least one of a time restriction for channel measurement and a time restriction for interference measurement. In some embodiments of this aspect, when at least one of the channel measurement restriction and the interference measurement restriction is configured to the WD, the number of samples is 1, otherwise; the numbers of samples is greater than 1. In some embodiments of this aspect, the measurement period for the L1-SINR measurement is a function of at least one of: the number of samples, a transmission period of the at least one channel measurement resource in time domain, a transmission period of the at least one interference measurement resource in time domain, an L1-SINR reporting period, and a scaling factor.

According to yet another aspect of the present disclosure, a wireless device, WD, configured to communicate with a network node is provided. The WD comprising processing circuitry. The processing circuitry is configured to cause the WD to determine a number of samples for a Layer 1 signal-to-interference-plus-noise ratio, L1-SINR, measurement, the number of samples being based at least in part on at least one measurement restriction parameter; determine a measurement period for the L1-SINR measurement based at least in part on the determined number of samples; and perform the L1-SINR measurement on at least one channel measurement resource and at least one interference measurement resource, the L1-SINR measurement being based at least in part on the determined number of samples and the measurement period.

In some embodiments of this aspect, the processing circuitry is configured to cause the WD to determine the number of samples by being configured to: when the at least one measurement restriction parameter indicates a restriction on at least one of a channel measurement and an interference measurement, determine that the number of samples is 1. In some embodiments of this aspect, the processing circuitry is configured to cause the WD to determine the number of samples by being configured to: when the at least one measurement restriction parameter indicates that there is a lack of a restriction on any of the channel measurement and the interference measurement, determine that the numbers of samples is greater than 1. In some embodiments of this aspect, the processing circuitry is configured to cause the WD to determine the number of samples by being configured to: when the at least one measurement restriction parameter indicates that there is a lack of a restriction on any of the channel measurement and the interference measurement, determine that the numbers of samples is 3.

In some embodiments of this aspect, the processing circuitry is further configured to cause the WD to receive a configuration including the at least one measurement restriction parameter. In some embodiments of this aspect, the at least one measurement restriction parameter comprises at least one of a time restriction for channel measurement and a time restriction for interference measurement. In some embodiments of this aspect, the processing circuitry is further configured to cause the WD to: when at least one of the channel measurement restriction and the interference measurement restriction is configured to the WD, determine that the number of samples is 1, otherwise; determine that the numbers of samples is greater than 1.

In some embodiments of this aspect, the processing circuitry is configured to cause the WD to determine the measurement period by being configured to cause the WD to: determine the measurement period for the L1-SINR measurement as a function of at least one of: the determined number of samples, a transmission period of the at least one channel measurement resource in time domain, a transmission period of the at least one interference measurement resource in time domain, an L1-SINR reporting period, and a scaling factor.

According to another aspect of the present disclosure, a network node configured to communicate with a wireless device, WD, is provided. The network node comprises processing circuitry. The processing circuitry is configured to cause the network node to send a configuration comprising at least one measurement restriction parameter to the WD, the at least one measurement restriction parameter associated with a Layer 1 signal-to-interference-plus-noise ratio, L1-SINR, measurement; and receive an L1-SINR report from the WD, the L1-SINR report being based at least in part on an L1 SINR measurement on at least one channel measurement resource and at least one interference measurement resource over a measurement period, the measurement period being based at least in part on a number of samples, the number of samples being based at least in part on the at least one measurement restriction parameter.

In some embodiments of this aspect, when the at least one measurement restriction parameter indicates a restriction on at least one of a channel measurement and an interference measurement, the number of samples is 1. In some embodiments of this aspect, when the at least one measurement restriction parameter indicates that there is a lack of a restriction on any of the channel measurement and the interference measurement, the numbers of samples is 3. In some embodiments of this aspect, when the at least one measurement restriction parameter indicates that there is a lack of a restriction on any of the channel measurement and the interference measurement, the numbers of samples is greater than 1. In some embodiments of this aspect, the at least one measurement restriction parameter comprises at least one of a time restriction for channel measurement and a time restriction for interference measurement.

In some embodiments of this aspect, when at least one of the channel measurement restriction and the interference measurement restriction is configured to the WD, the number of samples is 1, otherwise; the numbers of samples is greater than 1. In some embodiments of this aspect, the measurement period for the L1-SINR measurement is a function of at least one of: the number of samples, a transmission period of the at least one channel measurement resource in time domain, a transmission period of the at least one interference measurement resource in time domain, an L1-SINR reporting period, and a scaling factor.

According to another aspect of the present disclosure, an apparatus comprising computer program instructions executable by at least one processor to perform any of the methods above is provided.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of CMR/IMR transmission;

FIG. 2 is a schematic diagram of an exemplary network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating exemplary methods implemented in a communication system including a host computer, a network node and a wireless device for executing a client application at a wireless device according to some embodiments of the present disclosure;

FIG. 5 is a flowchart illustrating exemplary methods implemented in a communication system including a host computer, a network node and a wireless device for receiving user data at a wireless device according to some embodiments of the present disclosure;

FIG. 6 is a flowchart illustrating exemplary methods implemented in a communication system including a host computer, a network node and a wireless device for receiving user data from the wireless device at a host computer according to some embodiments of the present disclosure;

FIG. 7 is a flowchart illustrating exemplary methods implemented in a communication system including a host computer, a network node and a wireless device for receiving user data at a host computer according to some embodiments of the present disclosure;

FIG. 8 is a flowchart of an exemplary process in a network node for configuration unit according to some embodiments of the present disclosure;

FIG. 9 is a flowchart of an exemplary process in a wireless device for measurement unit according to some embodiments of the present disclosure;

FIG. 10 is a flowchart of another example process in a network node for configuration unit according to some embodiments of the present disclosure; and

FIG. 11 is a flowchart of another example process in a wireless device for measurement unit according to some embodiments of the present disclosure.

### DETAILED DESCRIPTION

An arrangement to control the number of measurement resources for channel measurement has been introduced in 3GPP, and is referred to as “measurement restriction”. When the network node configures the WD with a measurement restriction, the WD performs measurement based only on the most recent measurement resources. The 3GPP specification may allow the network to configure the measurement restriction for channel power and interference independently. The former restriction is called channel measurement restriction and latter one is called interference measurement restriction.

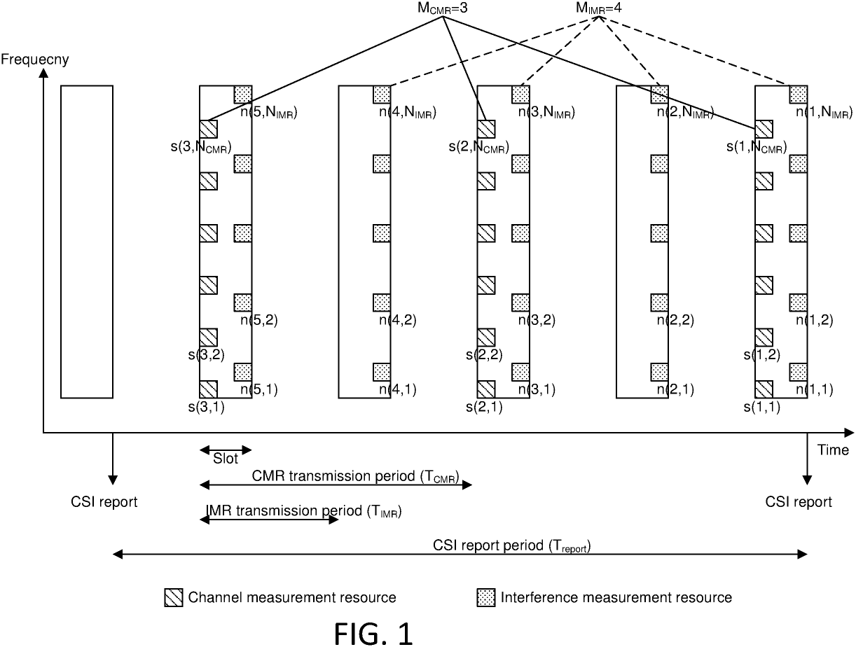

In the case of FIG. 1, for example, the WD performs the power measurement based only on the s(1, k) sample when the network node configures the channel measurement restriction. Similarly, when the network node configures the interference measurement restriction, the WD performs the interference estimation based only on the n(1, k) sample.

With this independent configuration of measurement restriction for channel and interference measurement, the WD measurement behavior (such as the measurement period, measurement averaging, etc.) is undefined.

Some embodiments of the present disclosure provide arrangements for the measurement samples for L1-SINR estimation.

In one embodiment, if the network node does not configure the WD with any of the channel measurement restriction and interference measurement restriction, then the WD estimates L1-SINR based on at least M_{CMR} number of recent samples of the channel measurement resources and at least M_{IMR} number of recent samples of the interference measurement resources, where M_{CMR} > 1 and M_{IMR} > 1 (e.g., M_{CMR} = 3 and M_{IMR} = 3). In this case, the WD may perform time domain filtering using e.g., at least 2 samples for both signal/channel and interference measurements for estimating the L1-SINR measurement.

In one embodiment, if the network node configures the WD with channel measurement restriction and/or interference measurement restriction, then the WD estimates L1-SINR based only on the most recent channel measurement resources (i.e., only the latest channel measurement resource) and the most recent interference measurement resources (i.e., only the latest interference measurement resources), which corresponds to M_{CMR}=M_{IMR}=1 . In this case the WD may not perform any time domain filtering for estimating signal/channel and interference measurements for the L1-SINR measurement.

Another embodiment is on the measurement period for L1-SINR reporting. In such embodiment, the measurement period may be derived as function of the measurement samples (M_{CMR} and M_{IMR}) and the measurement resource transmission periods (T_{CMR} and T_{IMR}), that is, T_{L1-SINR_}ₘₑₐₛ = f (M_{CMR}, M_{IMR}, T_{CMR}, T_{IMR}, G), where G is a scaling factor.

Some embodiments of the present disclosure may advantageously provide one or more of:
the network can control the number of measurement samples for L1-SINR estimation used by the WD;
the network can reduce the number of signaling to control the number of measurement samples for L1-SINR; and/or
the L1 SINR measurement may become more reliable and more representative of the actual channel/interference conditions since it is measured over a same number of resources.

Before describing in detail exemplary embodiments, it is noted that the embodiments reside primarily in combinations of apparatus components and processing steps related to Open Systems Interconnection (OSI) Layer 1 (L1) signal-to-interference-plus-noise ratio (SINR) measurement procedure based on measurement restrictions. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node is the transmitter and the receiver is the WD. For the UL communication, the transmitter is the WD and the receiver is the network node.

Any two or more embodiments described in this disclosure may be combined in any way with each other.

Generally, it may be considered that the network, e.g. a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g. information or payload bits, or total number of bits. The set of resources, and/or the resources of the sets, may pertain to the same carrier and/or bandwidth part, and/or may be located in the same slot, or in neighboring slots.

Receiving (or obtaining) information may comprise receiving one or more information messages (e.g., a measurement restriction parameter). It may be considered that receiving signaling comprises demodulating and/or decoding and/or detecting, e.g. blind detection of, one or more messages, in particular a message carried by the control signaling, e.g. based on an assumed set of resources, which may be searched and/or listened for the information. It may be assumed that both sides of the communication are aware of the configurations, and may determine the set of resources, e.g. based on the reference size.

An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., measurement restriction parameter, number of samples, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a terminal or wireless device (WD) or node may involve instructing and/or causing the wireless device or node to change its configuration, e.g., at least one setting and/or register entry and/or operational mode. A terminal or wireless device or node may be adapted to configure itself, e.g., according to information or data in a memory of the terminal or wireless device (e.g., pre-configured rule or received information). Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which a measurement restriction and/or numbers of samples to use for a measurement to be reported.

### Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

The term “radio measurement” used herein may refer to any measurement performed on radio signals. Radio measurements can be absolute or relative. Radio measurement may be called as signal level which may be signal quality and/or signal strength. Radio measurements can be e.g. intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc. The inter-frequency and inter-RAT measurements are carried out by the WD in measurement gaps unless the WD is capable of doing such measurement without gaps. Examples of measurement gaps are measurement gap id # 0 (each gap of 6 ms occurring every 40 ms), measurement gap id # 1 (each gap of 6 ms occurring every 80 ms), etc. The measurement gaps are configured at the WD by the network node.

Although the description herein may be explained in the context of an L1 SINR channel, it should be understood that the principles may also be applicable to other communication channels.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

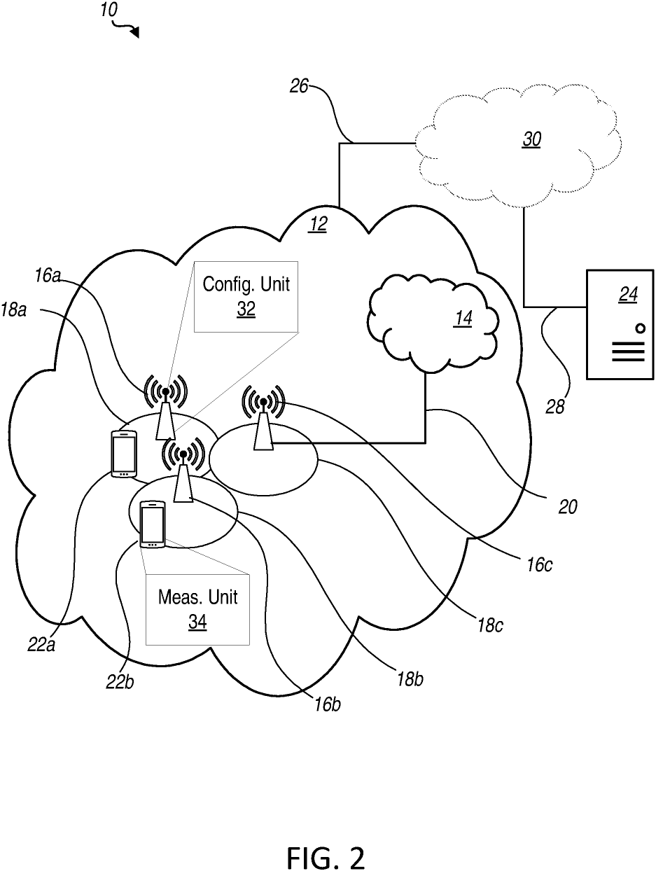

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to send a configuration comprising at least one measurement restriction parameter to the WD, the at least one measurement restriction parameter associated with a Layer 1 signal-to-interference-plus-noise ratio, L1-SINR, measurement; and receive an L1-SINR report from the WD, the L1-SINR report being based at least in part on an L1 SINR measurement on at least one channel measurement resource and at least one interference measurement resource over a measurement period, the measurement period being based at least in part on a number of samples, the number of samples being based at least in part on the at least one measurement restriction parameter.

In some embodiments, the network node 16 includes configuration unit 32 which is configured to one or more of: configure the WD with at least one measurement restriction parameter associated with an Open Systems Interconnection (OSI) Layer 1 (L1) signal-to-interference-plus-noise ratio (SINR) measurement; and receive, from the WD, an L1 SINR report based at least in part on an L1 SINR measurement on channel measurement resources and interference measurement resources, the L1 SINR measurement based at least in part on a first number of samples, M_{CMR}, for channel measurement and a second number of samples, M_{IMR}, for interference measurement and at least one measurement period, the first and second numbers of samples being based at least in part on the at least one measurement restriction parameter and the at least one measurement period based at least in part on the first and second numbers of samples.

A wireless device 22 is configured to include a measurement unit 34 which is configured to determine a number of samples for a Layer 1 signal-to-interference-plus-noise ratio, L1-SINR, measurement, the number of samples being based at least in part on at least one measurement restriction parameter; determine a measurement period for the L1-SINR measurement based at least in part on the determined number of samples; and perform the L1-SINR measurement on at least one channel measurement resource and at least one interference measurement resource, the L1-SINR measurement being based at least in part on the determined number of samples and the measurement period.

In some embodiments, wireless device 22 includes measurement unit 34 which is configured to one or more of: determine a first number of samples, M_{CMR}, for channel measurement and a second number of samples, M_{IMR}, for interference measurement for an Open Systems Interconnection (OSI) Layer 1 (L1) signal-to-interference-plus-noise ratio (SINR) measurement, the first and second numbers of samples being based at least in part on at least one measurement restriction parameter; determine at least one measurement period based at least in part on the first and second numbers of samples; and perform the L1 SINR measurement on channel measurement resources and interference measurement resources based at least in part on the determined numbers of samples and the at least one measurement period.

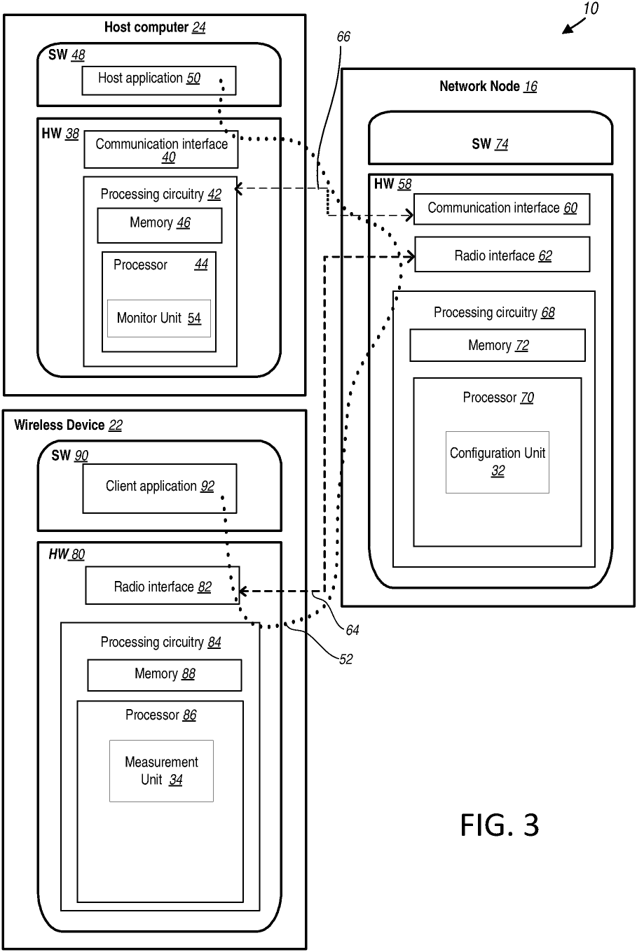

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

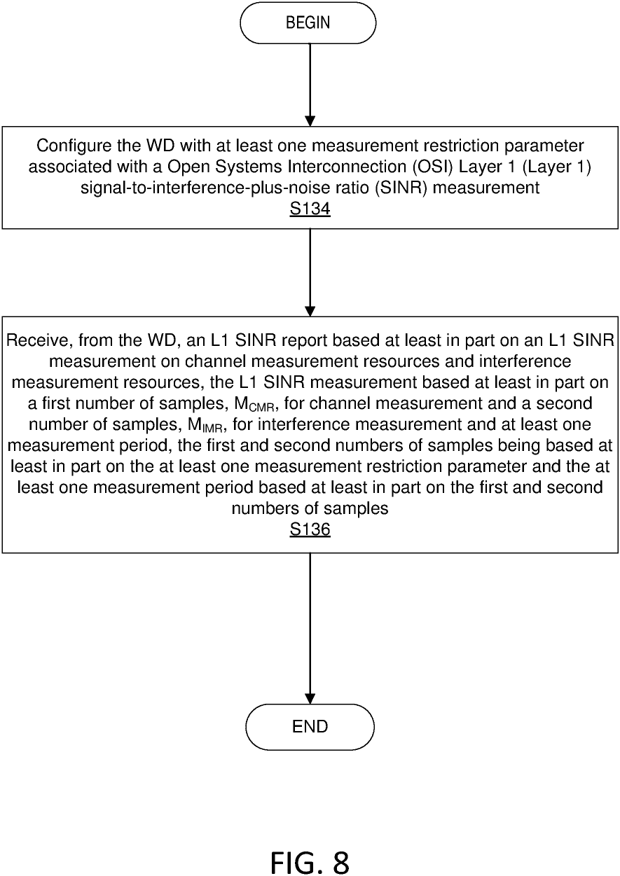

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform network node methods discussed herein, such as the methods discussed with reference to FIG. 8 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

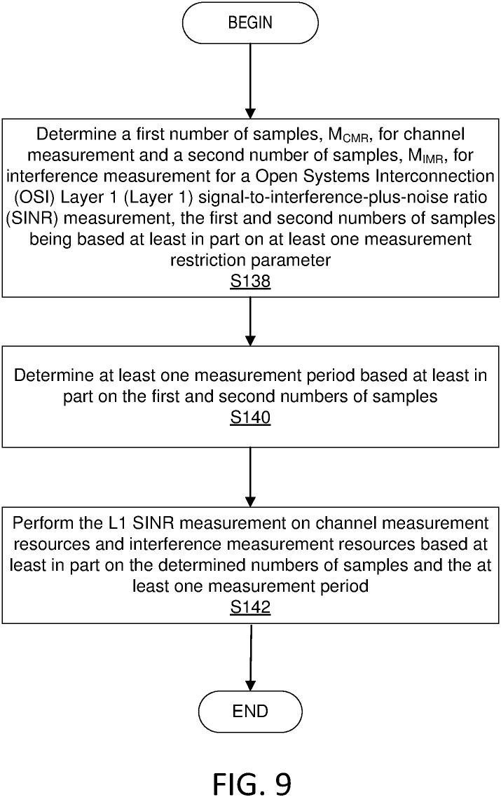

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a measurement unit 34 configured to perform WD methods discussed herein, such as the methods discussed with reference to FIG. 9 as well as other figures.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer’s 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node’s 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as configuration unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

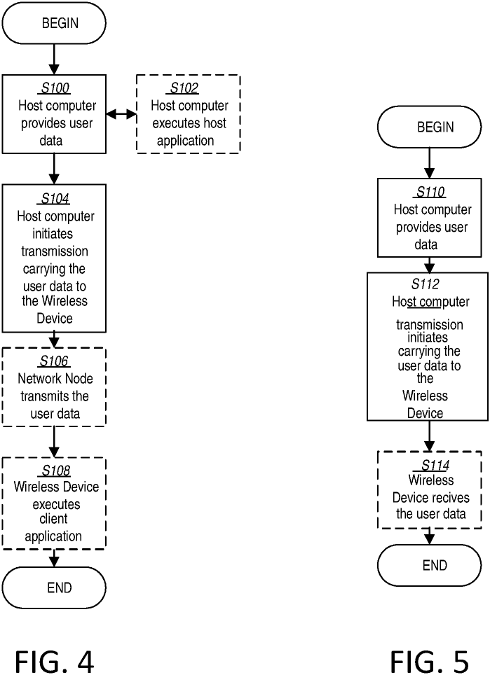

FIG. 4 is a flowchart illustrating an exemplary method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

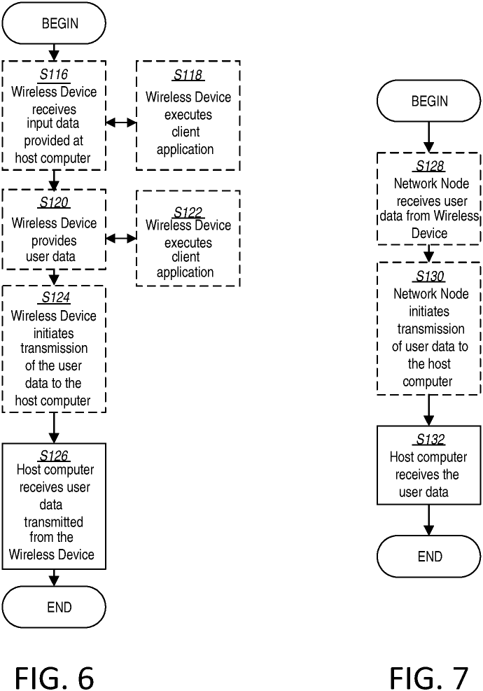

FIG. 6 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 8 is a flowchart of an exemplary process in a network node 16 for configuration according to some embodiments of the present disclosure. One or more Blocks and/or functions and/or methods performed by the network node 16 may be performed by one or more elements of network node 16 such as by configuration unit 32 in processing circuitry 68, processor 70, communication interface 60, radio interface 62, etc. according to the example method. The example method includes configuring (Block S134), such as via configuration unit 32, processing circuitry 68, processor 70, communication interface 60 and/or radio interface 62, the WD with at least one measurement restriction parameter associated with an Open Systems Interconnection (OSI) Layer 1 (L1) signal-to-interference-plus-noise ratio (SINR) measurement. The method includes receiving (Block S136), such as via configuration unit 32, processing circuitry 68, processor 70, communication interface 60 and/or radio interface 62, from the WD 22, an L1 SINR report based at least in part on an L1 SINR measurement on channel measurement resources and interference measurement resources, the L1 SINR measurement based at least in part on a first number of samples, M_{CMR}, for channel measurement and a second number of samples, M_{IMR}, for interference measurement and at least one measurement period, the first and second numbers of samples being based at least in part on the at least one measurement restriction parameter and the at least one measurement period based at least in part on the first and second numbers of samples.

In some embodiments, when the at least one measurement restriction parameter indicates a restriction on at least one of the channel measurement and the interference measurement, each of the numbers of samples is 1. In some embodiments, when the at least one measurement restriction parameter indicates that there is a lack of a restriction on at least one of the channel measurement and the interference measurement, each of the numbers of samples is greater than 1. In some embodiments, the numbers of samples are based at least in part on a relation between frequencies of two or more cells. In some embodiments, the numbers of samples are based at least in part on a frequency range in which the WD is operating. In some embodiments, the numbers of samples are based at least in part on an operational scenario in which the WD is operating. In some embodiments, the numbers of samples are based at least in part on a comparison of a most recent two L1-SINR measurements. In some embodiments, the numbers of samples are based at least in part on a reporting typ. In some embodiments, the numbers of samples are based at least in part on a level of cell synchronization.

In some embodiments, the at least one measurement period is a function of one or more of the first and second numbers of samples, a transmission period of the channel measurement resource in time domain, a transmission period of the interference measurement resource in time domain, an L1-SINR reporting period, and a scaling factor. In some embodiments, the first and second numbers of samples which are based at least in part on the at least one measurement restriction parameter is at least one of: configured to the WD; indicated to the WD; and pre-configured in the WD according to at least one predetermined rule.

FIG. 9 is a flowchart of an exemplary process in a wireless device 22 for measurement unit 34 according to some embodiments of the present disclosure. One or more Blocks and/or functions and/or methods performed by WD 22 may be performed by one or more elements of WD 22 such as by measurement unit 34 in processing circuitry 84, processor 86, radio interface 82, etc. The example method includes determining (Block S138), such as via measurement unit 34, processing circuitry 84, processor 86 and/or radio interface 82, a first number of samples, M_{CMR}, for channel measurement and a second number of samples, M_{IMR}, for interference measurement for an Open Systems Interconnection (OSI) Layer 1 (L1) signal-to-interference-plus-noise ratio (SINR) measurement, the first and second numbers of samples being based at least in part on at least one measurement restriction parameter. The method includes determining (Block S140), such as via measurement unit 34, processing circuitry 84, processor 86 and/or radio interface 82, at least one measurement period based at least in part on the first and second numbers of samples. The method includes performing (Block S142), such as via measurement unit 34, processing circuitry 84, processor 86 and/or radio interface 82, the L1 SINR measurement on channel measurement resources and interference measurement resources based at least in part on the determined numbers of samples and the at least one measurement period.

In some embodiments, the method includes receiving, such as via measurement unit 34, processing circuitry 84, processor 86 and/or radio interface 82, a configuration including the at least one measurement restriction parameter. In some embodiments, determining the numbers of samples based at least in part on the at least one measurement restriction parameter further includes at least one of, such as via measurement unit 34, processing circuitry 84, processor 86 and/or radio interface 82,: when the at least one measurement restriction parameter indicates a restriction on at least one of the channel measurement and the interference measurement, determining that each of the numbers of samples is 1; when the at least one measurement restriction parameter indicates that there is a lack of a restriction on at least one of the channel measurement and the interference measurement, determining that each of the numbers of samples is greater than 1; determining the numbers of samples based at least in part on a relation between frequencies of two or more cells; determining the numbers of samples based at least in part on a frequency range in which the WD is operating; determining the numbers of samples based at least in part on an operational scenario in which the WD is operating; determining the numbers of samples based at least in part on a comparison of a most recent two L1-SINR measurements; determining the numbers of samples based at least in part on a reporting type; and/or determining the numbers of samples based at least in part on a level of cell synchronization.

In some embodiments, determining the at least one measurement period based at least in part on the first and second numbers of samples further includes determining, such as via measurement unit 34, processing circuitry 84, processor 86 and/or radio interface 82, the at least one measurement period as a function of one or more of the first and second numbers of samples, a transmission period of the channel measurement resource in time domain, a transmission period of the interference measurement resource in time domain, an L1-SINR reporting period, and a scaling factor.

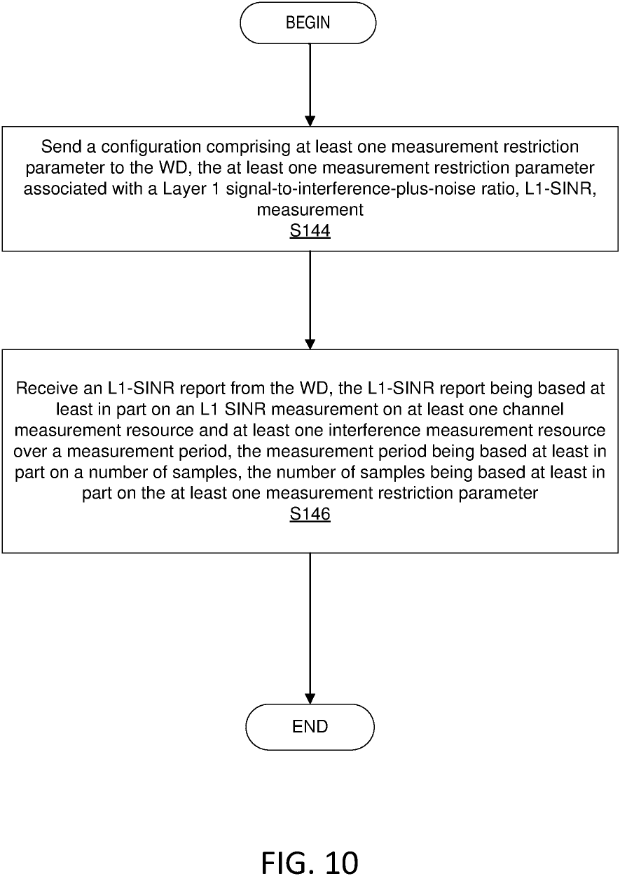

FIG. 10 is a flowchart of an exemplary process in a network node 16 for configuration according to some embodiments of the present disclosure. One or more Blocks and/or functions and/or methods performed by the network node 16 may be performed by one or more elements of network node 16 such as by configuration unit 32 in processing circuitry 68, processor 70, communication interface 60, radio interface 62, etc. according to the example method. The example method includes sending (Block S144), such as via configuration unit 32, processing circuitry 68, processor 70, communication interface 60 and/or radio interface 62, a configuration comprising at least one measurement restriction parameter to the WD, the at least one measurement restriction parameter associated with a Layer 1 signal-to-interference-plus-noise ratio, L1-SINR, measurement. The method includes receiving (Block S146), such as via configuration unit 32, processing circuitry 68, processor 70, communication interface 60 and/or radio interface 62, an L1-SINR report from the WD, the L1-SINR report being based at least in part on an L1 SINR measurement on at least one channel measurement resource and at least one interference measurement resource over a measurement period, the measurement period being based at least in part on a number of samples, the number of samples being based at least in part on the at least one measurement restriction parameter.

In some embodiments, when the at least one measurement restriction parameter indicates a restriction on at least one of a channel measurement and an interference measurement, the number of samples is 1. In some embodiments, when the at least one measurement restriction parameter indicates that there is a lack of a restriction on any of the channel measurement and the interference measurement, the numbers of samples is 3. In some embodiments, when the at least one measurement restriction parameter indicates that there is a lack of a restriction on any of the channel measurement and the interference measurement, the numbers of samples is greater than 1. In some embodiments, the at least one measurement restriction parameter comprises at least one of a time restriction for channel measurement and a time restriction for interference measurement.

In some embodiments, when at least one of the channel measurement restriction and the interference measurement restriction is configured to the WD, the number of samples is 1, otherwise; the numbers of samples is greater than 1. In some embodiments, the measurement period for the L1-SINR measurement is a function of at least one of: the number of samples, a transmission period of the at least one channel measurement resource in time domain, a transmission period of the at least one interference measurement resource in time domain, an L1-SINR reporting period, and a scaling factor.

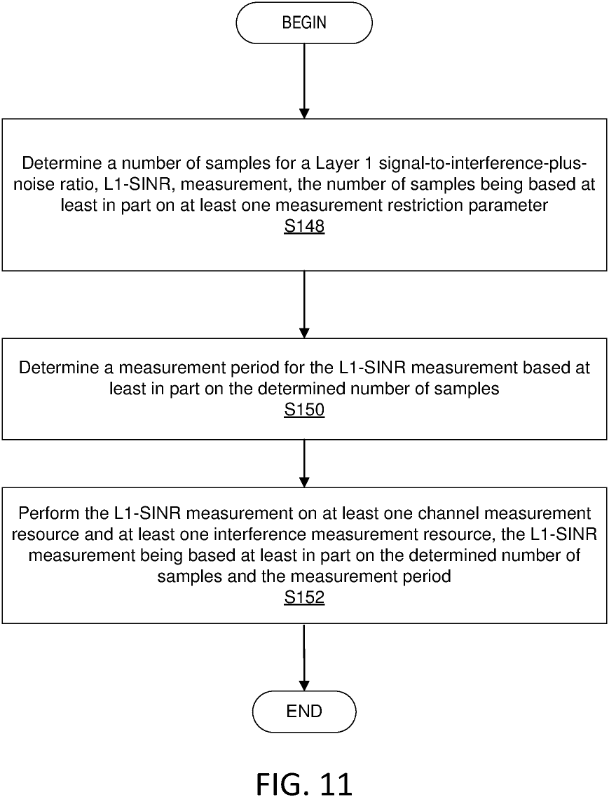

FIG. 11 is a flowchart of an exemplary process in a wireless device 22 for measurement unit 34 according to some embodiments of the present disclosure. One or more Blocks and/or functions and/or methods performed by WD 22 may be performed by one or more elements of WD 22 such as by measurement unit 34 in processing circuitry 84, processor 86, radio interface 82, etc. The example method includes determining (Block S148), such as via measurement unit 34, processing circuitry 84, processor 86 and/or radio interface 82, a number of samples for a Layer 1 signal-to-interference-plus-noise ratio, L1-SINR, measurement, the number of samples being based at least in part on at least one measurement restriction parameter. The method includes determining (Block S150), such as via measurement unit 34, processing circuitry 84, processor 86 and/or radio interface 82, a measurement period for the L1-SINR measurement based at least in part on the determined number of samples. The method includes performing (Block S152), such as via measurement unit 34, processing circuitry 84, processor 86 and/or radio interface 82, the L1-SINR measurement on at least one channel measurement resource and at least one interference measurement resource, the L1-SINR measurement being based at least in part on the determined number of samples and the measurement period.

In some embodiments, determining the number of samples based at least in part on the at least one measurement restriction parameter comprises: when the at least one measurement restriction parameter indicates a restriction on at least one of a channel measurement and an interference measurement, determining, such as via measurement unit 34, processing circuitry 84, processor 86 and/or radio interface 82, that the number of samples is 1. In some embodiments, determining the number of samples based at least in part on the at least one measurement restriction parameter comprises: when the at least one measurement restriction parameter indicates that there is a lack of a restriction on any of the channel measurement and the interference measurement, determining, such as via measurement unit 34, processing circuitry 84, processor 86 and/or radio interface 82, that the numbers of samples is greater than 1.

In some embodiments, determining the number of samples based at least in part on the at least one measurement restriction parameter comprises: when the at least one measurement restriction parameter indicates that there is a lack of a restriction on any of the channel measurement and the interference measurement, determining, such as via measurement unit 34, processing circuitry 84, processor 86 and/or radio interface 82, that the numbers of samples is 3. In some embodiments, the method further includes receiving, such as via measurement unit 34, processing circuitry 84, processor 86 and/or radio interface 82, a configuration including the at least one measurement restriction parameter. In some embodiments, the at least one measurement restriction parameter comprises at least one of a time restriction for channel measurement and a time restriction for interference measurement.

In some embodiments, determining the number of samples based at least in part on the at least one measurement restriction parameter comprises: when at least one of the channel measurement restriction and the interference measurement restriction is configured to the WD, determining, such as via measurement unit 34, processing circuitry 84, processor 86 and/or radio interface 82, that the number of samples is 1, otherwise; determining, such as via measurement unit 34, processing circuitry 84, processor 86 and/or radio interface 82, that the numbers of samples is greater than 1. In some embodiments, determining the measurement period for the L1-SINR measurement further comprises determining, such as via measurement unit 34, processing circuitry 84, processor 86 and/or radio interface 82, the measurement period as a function of at least one of: the determined number of samples, a transmission period of the at least one channel measurement resource in time domain, a transmission period of the at least one interference measurement resource in time domain, an L1-SINR reporting period, and a scaling factor.

Having described the general process flow of arrangements of the disclosure and having provided examples of hardware and software arrangements for implementing the processes and functions of the disclosure, the sections below provide details and examples of arrangements for L1-SINR measurement procedure based on measurement restrictions, which may be implemented by the network node 16, wireless device 22 and/or host computer 24.

### Method for WD Determining Number of Samples for L1-SINR Measurement

An example scenario may include a WD 22 configured by a network node (e.g., network node 16) to perform a signal quality measurement (Qs). Signal quality measurement, Qs, in linear scale is a ratio of a first component including a signal measurement and a second component including an interference measurement. In some embodiments, the first component may be measured on a reference signal (RS). Examples of RSs include CSI-RS, synchronization signal block (SSB), positioning reference signal (PRS), demodulation reference signal (DMRS), etc. The second component comprising interference received by the WD 22 from serving and one or more neighbor cells includes noise. Examples of the signal quality measurements include signal to noise ratio (SNR), SINR, L1-SINR, reference signal received quality (RSRQ), channel quality indicator (CQI), etc. Even though L1-SINR is used as an example for describing the embodiments it is understood that the embodiments are applicable for any type of signal quality measurement. Examples of a network node include a base station, gNodeB, eNodeB, access point, integrated access and backhaul (IAB) node, etc. The WD 22 is typically configured by a serving network node (e.g., serving network node 16) to perform Qs. The WD 22 may further be configured by the network node 16 to report the results of Qs to the network node 16, e.g., periodically, aperiodically, on event triggered basis (e.g., semi-persistent), etc. The WD 22 can be configured to perform Qs for one or multiple serving cells e.g., Qs1 for a special cell (SpCell) (such as a primary cell (PCell), a primary secondary cell (PSCell), etc.) and Qs2 for one or more secondary cells (SCells),

In some embodiments, the network node 16 can configure (e.g., via radio resource control signaling) the WD 22 with one or both or none of the two different types of the measurement restrictions: channel measurement restriction and interference measurement restriction. Examples of corresponding signaling parameters defined in 3GPP Technical Specification (TS) 38.331 version (v)15.7.0 include timeRestrictionForChannelMeasurements and timeRestrictionForInterferenceMeasurements, respectively.

| | |
|---|---|
| timeRestrictionForChannelMeasurements | ENUMERATED {configured, |
| notConfigured}, | |
| timeRestrictionForInterferenceMeasurements | ENUMERATED {configured, |
| notConfigured}, | |

In a first example implementation, the network node 16 does not configure the WD 22 with any of the two measurement restrictions. In one exemplary approach if the WD 22 does not receive information element or fields containing or defining the measurement restrictions then the WD 22 may assume that it is not configured with the measurement restrictions. In this case, that is when the network node 16 does not configure the WD 22 with both channel measurement restriction and interference measurement restriction for L1-SINR measurement, then the WD 22 performs the L1-SINR over a number of CMR transmission resources greater than 1 (i.e., M_{CMR} >1) and also number of IMR transmission resources greater than 1 (i.e., M_{IMR} >1). The parameters M_{CMR} and M_{IMR} may also be called as or correspond to the number of channel measurement samples and the number of interference measurement samples, respectively. The channel measurement sample may also be called as signal measurement sample, reference signal measurement sample, etc. The use of M_{CMR} >1 and M_{IMR} >1 for L1-SINR measurement may provide the WD 22 more measurement processing time before using the measurement results for operational tasks. The WD 22 complexity may be reduced due to longer processing delay but it may require storing of older samples unless the measurement is completed, i.e., the memory size is increased.

One example of the number of samples (M_{CMR} >1 and M_{IMR} >1) that the WD 22 may obtain for the L1-SINR measurement are M_{CMR}=3 and M_{IMR}=4 (M_{CMR} ≠ M_{IMR}). Another example is M_{CMR}=3 and M_{IMR}=3 (M_{CMR} = M_{IMR}). The network node 16 may not configure the WD 22 with any of the two different types of the measurement restrictions if the network node 16 wants the WD 22 to perform L1-SINR measurement using multiple samples. An example scenario may be, for example, when the WD 22 is stationary or moving with a speed below a certain threshold.

In a second example implementation, the network node 16 configures the WD 22 with at least one of the two measurement restriction parameters (e.g., with channel measurement restriction and/or interference measurement restriction). In this case, when the network node 16 configures channel measurement restriction and/or interference measurement restriction for L1-SINR measurement, then the WD 22 estimates L1-SINR based only on the recent transmitted channel measurement resource (i.e., M_{CMR}=1) and the recent transmitted interference measurement resources (i.e., M_{IMR}=1). In order to reduce signaling overhead, the network node 16 may configure the WD 22 with only one of the two different types of the measurement restrictions. Due to a well-defined WD 22 behavior according to this embodiment, the WD 22 can measure L1-SINR based on a single channel measurement sample and a single interference measurement sample.

According to a third example implementation, if the WD 22 is configured with at least two serving cells in multicarrier operation (e.g., carrier aggregation, dual connectivity, etc.) then the WD 22 estimates L1-SINR for two or more serving cells based on the relation between frequencies of those serving cells. For example, if the frequencies of the serving cells are associated by a relation then the WD 22 estimates L1-SINR based on M_{CMR} =1 and M_{IMR} =1 for the at least two serving cells even if the WD 22 is configured by the network node 16 with only one of the two measurement restriction parameters for one of the two serving cells. Otherwise, the WD 22 may estimate L1-SINR based on M_{CMR} >1 and M_{IMR} >1 for the at least two serving cells. In another example, if the WD 22 is configured with at least one of the two measurement restriction parameters for specific serving cell (e.g., SpCell) then the WD 22 estimates L1-SINR based on M_{CMR} =1 and M_{IMR} =1 for that specific serving cell and for one or more serving cells (e.g., SCell) whose frequencies are associated by a certain relation (e.g. SpCell and SCell frequencies belong the same band and/or to specific frequency range (FR) e.g., Frequency 2 (FR2)). Otherwise, the WD 22 estimates L1-SINR based on M_{CMR} >1 and M_{IMR} >1 for the these serving cells. Examples of the relations include one or combinations of the following: carrier frequencies of the serving cells belong to the same band, carrier frequencies of the serving cells are within a certain carrier frequency threshold (Hf) (e.g., Hf = 500 MHz), carrier frequencies of the serving cells belong to a particular frequency range (FR) (e.g., FR2). In multicarrier operation the WD 22 may be configured with one or more SpCell (e.g., PCell and SCell) and one or more SCells.

According to a fourth example implementation, even if the WD 22 is configured by the network node 16 with only one of the two measurement restriction parameters, the WD 22 may estimate L1-SINR based on M_{CMR} >1 and M_{IMR} >1 or M_{CMR} =1 and M_{IMR} =1, depending on the frequency range (FR) in which the WD 22 is operating. In one example, if the WD 22 is operating in the serving cell (cell1) belonging to a particular FR (e.g., in FR2) then the WD 22 estimates L1-SINR based on M_{CMR} =1 and M_{IMR} =1; otherwise, if cell 1 belongs to another FR (e.g., FR1) then the WD 22 estimates L1-SINR based on M_{CMR} >1 and M_{IMR} >1. Examples of FR1 and FR2 are frequency ranges between 410 MHz to 7.125 GHz, and between 24.25 GHz and 52.6 GHz, respectively.

According to a fifth example implementation, even if the WD 22 is configured by the network node 16 with only one of the two measurement restriction parameters, the WD 22 may estimate L1-SINR based on M_{CMR} >1 and M_{IMR} >1 or M_{CMR} =1 and M_{IMR} =1, depending on the operational scenario in which the WD 22 is operating in its serving cell (cell 1). Examples of WD 22 operational scenarios (OS) may include at least two of the following 3 possible scenarios:
Operational scenario # 1 (OS#1): WD 22 operating at low speed e.g., WD 22 speed below threshold (e.g. below 5 km/hour).
Operational scenario # 2 (OS#2): WD 22 operating not at serving cell’s edge or operating in serving cell’s center (e.g., WD 22 signal level with respect to serving cell is above a certain signal threshold).
Operational scenario # 3 (OS#3): WD 22 operating at low speed and not-at-serving cell edge (i.e., combination of OS#1 and OS#2).

Every OS may be associated with its respective one or more criteria or conditions. The WD 22 determines the OS in which it is operating provided that the corresponding criteria for that OS are met.

In one example of OS determination, the WD 22 can be informed by the network node 16 of the OS in which the WD 22 is operating. In this case the network node 16 may determine the OS of the WD 22 (e.g., based on WD reporting measurements, WD positioning, etc.). In another example, the WD 22 autonomously determines the OS in which the WD 22 is operating e.g., based on WD 22 measurements (e.g., RSRP, RSRQ, etc.), Doppler frequency estimation, WD 22 position (e.g., based on Global Navigation Satellite System (GNSS), etc.) etc.

One or more possible impacts of the WD’s 22 OS on the L1-SINR are described with examples below:
In one example, when the WD 22 is operating in OS#2 then the WD 22 estimates L1-SINR based on M_{CMR} =1 and M_{IMR} =1; otherwise, when the WD 22 is operating in any of OS#1 and OS#3 then the WD 22 estimates L1-SINR based on M_{CMR} >1 and M_{IMR} >1 (e.g., M_{CMR} =3 and M_{IMR} =3). One reason is that WD 22 operating in OS#2 may be expected to be moving quite fast, i.e., it is not expected to be a low mobility or stationary device. Since the WD 22 may be moving fast, the WD 22 may not have very long time to make a filtered measurement with multiple measurement samples. Thus, the WD 22 may be configured to measure L1-SINR quicker than in the scenario where the WD 22 is expected to be low mobility or fully stationary.
In another example, when the WD 22 is operating in OS#1 or in OS#2 then the WD 22 estimates L1-SINR based on M_{CMR} =1 and M_{IMR} =1; otherwise, if the WD 22 is operating in OS#3 then the WD 22 is required to estimate L1-SINR based on M_{CMR} >1 and M_{IMR} >1 (e.g., M_{CMR} =3 and M_{IMR} =3). One reason is that when the WD 22 is operating in OS#3, it may be expected to be in good coverage (e.g., near the cell serving base station, in the center of the cell, not at cell edge) and of low mobility. In such ideal conditions, it may be acceptable to make a filtered/averaged L1-SINR measurement and report more accurate measurement value, since presumably the WD 22 has enough time to take samples.
In yet another example, when the WD 22 is operating in OS#1 or OS#3 (i.e. scenarios where the WD 22 is expected to be of low mobility) and the WD 22 has been configured with only one of the two measurement restriction parameters, then the WD 22 performs L1-SINR based on M_{CMR} > 1 and M_{IMR} =1 or based on M_{CMR} =1 and M_{IMR} >1. One reason is that since the WD 22 may be of low-mobility, the measured value (channel measurement or interference part of the measurement) may not change very much, e.g., the surroundings may be the same, inter-cell interference may not change significantly. In this case, by adapting the assumptions on the measurement restriction based on the operating scenario, the WD 22 can reduce its power consumption.
In still yet another example, when the WD 22 has been configured with any of the criteria (associated with OS#1, OS#2, OS#3), then the WD 22 always performs L1-SINR measurement based on the assumption measurement restriction that has been configured on both components.

According to a sixth example implementation, even when the WD 22 is configured by the network node 16 with only one of the two measurement restriction parameters, or configured with measurement restriction on both measurement components, the WD 22 compares the last two L1-SINR measurements or the last two channel powers and interference estimations, e.g., comparison of the magnitude of the absolute difference between the two values. In one embodiment, when the difference is less than a certain threshold, T, then the WD 22 measures L1-SINR as if the network configures the measurement restrictions on both components. Otherwise, the WD 22 performs L1-SINR based on M_{CMR} >1 and M_{IMR} >1.

According to a seventh example implementation, even if the WD 22 is configured by the network node 16 with only one of the two measurement restriction parameters, whether the WD 22 measures L1-SINR based on measurement restriction on both components depends on the L1-SINR reporting type (e.g., periodic, aperiodic, or semi-persistent) that has been configured. For example, when the WD 22 has been configured with aperiodic reporting, then the WD 22 measures L1-SINR based on M_{CMR} >1 and M_{IMR} >1. However, if the WD 22 is configured with periodic reporting, then the WD 22 measures L1-SINR by assuming measurement restriction on both components.

According to eighth example implementation, even if the WD 22 is configured by the network node 16 with only one of the two measurement restriction parameters, whether the WD 22 measures L1-SINR based on measurement restriction on both components depends on the level of synchronization with respect to the serving cell. The level of synchronization includes timing drift, frequency drift, in-sync indication, out-of-sync indication. In some embodiments, when the WD 22 is synchronized to the serving cell, then the WD 22 assumes measurement restriction on the channel measurement resource only, i.e., M_{CMR} = 1 and M_{IMR} >1, because in this case only the interference part of the measurements is expected to change significantly.

### Example Method for WD Adapting L1-SINR Measurement Period Based on Determined Samples

After determining the values of M_{CMR} and M_{IMR} according to any of the methods in the example implementations (such as those described herein above), the WD 22 determines the L1-SINR measurement period. In some embodiments, the L1-SINR measurement period is a function of at least M_{CMR} and M_{IMR} as described below with several examples:

In this example, the WD 22 performs the measurement of L1-SINR with the measurement period of T_{L1-SINR}ₘₑₐₛ given as a function f(.) given as follows in the case of no discontinuous reception (DRX) configuration (i.e., WD 22 is not configured with DRX): T_{L1}_{SINR}ₘₑₐₛ = f (M_{CMR}, M_{IMR}, T_{CMR}, T_{IMR}, Tᵣₑₚₒᵣₜ, G), where,
M_{CMR}: Number of channel measurement resource transmission occasions in time domain;
M_{IMR}: Number of interference measurement resource transmission occasions in time domain;
T_{CMR}: Transmission period of channel measurement resource in time domain;
T_{IMR}: Transmission period of interference measurement resource in time domain;
Tᵣₑₚₒᵣₜ: L1-SINR reporting period; and
G: Scaling factor.

Example of f(.) is:
f(M_{CMR}, M_{IMR}, T_{CMR}, T_{IMR}, Tᵣₑₚₒᵣₜ, G) := max(Tᵣₑₚₒᵣₜ, ceil(max(M_{CMR}, M_{IMR}) * G * max(T_{CMR}, T_{IMR}) ),
where ceil(X) is a function to Return the smallest integer not less than X, and max(A, B, ...) is a function to return the maximum value of the parameters.

In some embodiments, the WD 22 may perform the L1-SINR measurement over the determined measurement period. After performing the L1-SINR measurement the WD 22 uses the measurement results for one or more operational tasks, e.g., using the results for beam management (BM) procedure, reporting the results to the network node 16, etc. Examples of BM procedure may include determining the quality of a beam, determining candidate beams for receiving signals from cell1, etc.

Examples of G include a measurement gap factor when the WD 22 is configured to perform the L1-SINR measurement using measurement gaps and G ≥ 1.0. Examples of L1-SINR measurements include inter-frequency measurement and/or intra-frequency measurement and/or inter-radio access technology (inter-RAT) measurement. Another example of G is the WD 22 receiver beamforming factor. If the WD 22 is capable of receiver beamforming especially in higher frequency bands such as 28 GHz or 39 GHz, it takes more time to tune the Rx beamformer to the optimum direction. For the Rx beamforming, an example of G is 8. Yet another example of G is a function of a measurement gap factor (e.g., G1) and WD 22 Rx beamforming factor (e.g., G2). An example of the function is multiplication e.g., G = G1*G2.

In some embodiments, when the WD 22 is configured with DRX, the WD 22 can monitor the CMR and IMR only in on-duration period. Therefore, the measurement period of L1-SINR T_{L1-SINR_meas} with the DRX configuration may be given as a function f(.), such as for example:

$${\text{T}}_{\text{L1-SINR\_meas}} = \text{f} \left({\text{M}}_{\text{CMR,}} {\text{M}}_{\text{IMR,}} {\text{T}}_{\text{CMR,}} {\text{T}}_{\text{IMR,}} {\text{T}}_{\text{report,}} {\text{T}}_{\text{DRX,}} \text{G}\right) ,$$

where,
M_{CMR}: Number of channel measurement resource transmission occasions in time domain;
M_{IMR}: Number of interference measurement resource transmission occasions in time domain;
T_{CMR}: Transmission period of channel measurement resource in time domain;
T_{IMR}: Transmission period of interference measurement resource in time domain;
Tᵣₑₚₒᵣₜ: L1-SINR reporting period;
T_{DRX}: DRX cycle length; and
G: Scaling factor.

Examples of f(.) may also include: f(M_{CMR}, M_{IMR}, T_{CMR}, T_{IMR}, Tᵣₑₚₒᵣₜ, T_{DRX}, G) := max(Tᵣₑₚₒᵣₜ, ceil(max(M_{CMR}, M_{IMR}) * G * max(T_{CMR}, T_{IMR}, T_{DRX}) ) ).

Some embodiments may include one or more of the following:

Embodiment A1. A network node configured to communicate with a wireless device (WD), the network node configured to, and/or comprising a radio interface and/or comprising processing circuitry configured to at least one of:
configure the WD with at least one measurement restriction parameter associated with an Open Systems Interconnection (OSI) Layer 1 (L1) signal-to-interference-plus-noise ratio (SINR) measurement; and
receive, from the WD, an L1 SINR report based at least in part on an L1 SINR measurement on channel measurement resources and interference measurement resources, the L1 SINR measurement based at least in part on a first number of samples, M_{CMR}, for channel measurement and a second number of samples, M_{IMR}, for interference measurement and at least one measurement period, the first and second numbers of samples being based at least in part on the at least one measurement restriction parameter, and the at least one measurement period based at least in part on the first and second numbers of samples.

Embodiment A2. The network node of Embodiment A1, wherein:
when the at least one measurement restriction parameter indicates a restriction on at least one of the channel measurement and the interference measurement, each of the numbers of samples is 1; and/or
when the at least one measurement restriction parameter indicates that there is a lack of a restriction on at least one of the channel measurement and the interference measurement, each of the numbers of samples is greater than 1; and/or
the numbers of samples are based at least in part on a relation between frequencies of two or more cells; and/or
the numbers of samples are based at least in part on a frequency range in which the WD is operating; and/or
the numbers of samples are based at least in part on an operational scenario in which the WD is operating; and/or
the numbers of samples are based at least in part on a comparison of a most recent two L1-SINR measurements; and/or
the numbers of samples are based at least in part on a reporting type; and/or
the numbers of samples are based at least in part on a level of cell synchronization.

Embodiment A3. The network node of Embodiment A1, wherein the at least one measurement period is a function of one or more of the first and second numbers of samples, a transmission period of the channel measurement resource in time domain, a transmission period of the interference measurement resource in time domain, an L1-SINR reporting period, and a scaling factor.

Embodiment A4. The network node of Embodiment A1, wherein the first and second numbers of samples which are based at least in part on the at least one measurement restriction parameter is at least one of:
configured to the WD;
indicated to the WD; and
pre-configured in the WD according to at least one predetermined rule.

Embodiment B1. A method implemented in a network node, the method comprising:
configuring the WD with at least one measurement restriction parameter associated with an Open Systems Interconnection (OSI) Layer 1 (L1) signal-to-interference-plus-noise ratio (SINR) measurement; and
receiving, from the WD, an L1 SINR report based at least in part on an L1 SINR measurement on channel measurement resources and interference measurement resources, the L1 SINR measurement based at least in part on a first number of samples, M_{CMR}, for channel measurement and a second number of samples, M_{IMR}, for interference measurement and at least one measurement period, the first and second numbers of samples being based at least in part on the at least one measurement restriction parameter and the at least one measurement period based at least in part on the first and second numbers of samples.

Embodiment B2. The method of Embodiment B 1, wherein:
when the at least one measurement restriction parameter indicates a restriction on at least one of the channel measurement and the interference measurement, each of the numbers of samples is 1; and/or
when the at least one measurement restriction parameter indicates that there is a lack of a restriction on at least one of the channel measurement and the interference measurement, each of the numbers of samples is greater than 1; and/or
the numbers of samples are based at least in part on a relation between frequencies of two or more cells; and/or
the numbers of samples are based at least in part on a frequency range in which the WD is operating; and/or
the numbers of samples are based at least in part on an operational scenario in which the WD is operating; and/or
the numbers of samples are based at least in part on a comparison of a most recent two L1-SINR measurements; and/or
the numbers of samples are based at least in part on a reporting type; and/or
the numbers of samples are based at least in part on a level of cell synchronization.

Embodiment B3. The method of Embodiment B1, wherein the at least one measurement period is a function of one or more of the first and second numbers of samples, a transmission period of the channel measurement resource in time domain, a transmission period of the interference measurement resource in time domain, an L1-SINR reporting period, and a scaling factor.

Embodiment B4. The method of Embodiment B1, wherein the first and second numbers of samples which are based at least in part on the at least one measurement restriction parameter is at least one of:
configured to the WD;
indicated to the WD; and
pre-configured in the WD according to at least one predetermined rule.

Embodiment C1. A wireless device (WD) configured to communicate with a network node, the WD configured to, and/or comprising a radio interface and/or processing circuitry configured to at least one of:
determine a first number of samples, M_{CMR}, for channel measurement and a second number of samples, M_{IMR}, for interference measurement for an Open Systems Interconnection (OSI) Layer 1 (L1) signal-to-interference-plus-noise ratio (SINR) measurement, the first and second numbers of samples being based at least in part on at least one measurement restriction parameter;
determine at least one measurement period based at least in part on the first and second numbers of samples; and
perform the L1 SINR measurement on channel measurement resources and interference measurement resources based at least in part on the determined numbers of samples and the at least one measurement period.

Embodiment C2. The WD of Embodiment C1, wherein the WD and/or the radio interface and/or the processing circuitry is configured to:
receive a configuration including the at least one measurement restriction parameter.

Embodiment C3. The WD of Embodiment C1, wherein the WD and/or the radio interface and/or the processing circuitry is configured to determine the numbers of samples based at least in part on the at least one measurement restriction parameter by being configured to at least one of:
when the at least one measurement restriction parameter indicates a restriction on at least one of the channel measurement and the interference measurement, determine that each of the numbers of samples is 1; and/or
when the at least one measurement restriction parameter indicates that there is a lack of a restriction on at least one of the channel measurement and the interference measurement, determine that each of the numbers of samples is greater than 1; and/or
determine the numbers of samples based at least in part on a relation between frequencies of two or more cells; and/or
determine the numbers of samples based at least in part on a frequency range in which the WD is operating; and/or
determine the numbers of samples based at least in part on an operational scenario in which the WD is operating; and/or
determine the numbers of samples based at least in part on a comparison of a most recent two L1-SINR measurements; and/or
determine the numbers of samples based at least in part on a reporting type; and/or
determine the numbers of samples based at least in part on a level of cell synchronization.

Embodiment C4. The WD of Embodiment C1, wherein the WD and/or the radio interface and/or the processing circuitry is configured to determine the at least one measurement period based at least in part on the first and second numbers of samples by being configured to:
determine the at least one measurement period as a function of one or more of the first and second numbers of samples, a transmission period of the channel measurement resource in time domain, a transmission period of the interference measurement resource in time domain, an L1-SINR reporting period, and a scaling factor.

Embodiment D1. A method implemented in a wireless device (WD), the method comprising one or more of:
determining a first number of samples, M_{CMR}, for channel measurement and a second number of samples, M_{IMR}, for interference measurement for an Open Systems Interconnection (OSI) Layer 1 (L1) signal-to-interference-plus-noise ratio (SINR) measurement, the first and second numbers of samples being based at least in part on at least one measurement restriction parameter;
determining at least one measurement period based at least in part on the first and second numbers of samples; and
performing the L1 SINR measurement on channel measurement resources and interference measurement resources based at least in part on the determined numbers of samples and the at least one measurement period.

Embodiment D2. The method of Embodiment D1, further comprising:
receiving a configuration including the at least one measurement restriction parameter.

Embodiment D3. The method of Embodiment D 1, wherein determining the numbers of samples based at least in part on the at least one measurement restriction parameter further comprises at least one of:
when the at least one measurement restriction parameter indicates a restriction on at least one of the channel measurement and the interference measurement, determining that each of the numbers of samples is 1; and/or
when the at least one measurement restriction parameter indicates that there is a lack of a restriction on at least one of the channel measurement and the interference measurement, determining that each of the numbers of samples is greater than 1; and/or
determining the numbers of samples based at least in part on a relation between frequencies of two or more cells; and/or
determining the numbers of samples based at least in part on a frequency range in which the WD is operating; and/or
determining the numbers of samples based at least in part on an operational scenario in which the WD is operating; and/or
determining the numbers of samples based at least in part on a comparison of a most recent two L1-SINR measurements; and/or
determining the numbers of samples based at least in part on a reporting type; and/or
determining the numbers of samples based at least in part on a level of cell synchronization.

Embodiment D4. The method of Embodiment D1, wherein determining the at least one measurement period based at least in part on the first and second numbers of samples further comprises:
determining the at least one measurement period as a function of one or more of the first and second numbers of samples, a transmission period of the channel measurement resource in time domain, a transmission period of the interference measurement resource in time domain, an L1-SINR reporting period, and a scaling factor.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user’s computer, partly on the user’s computer, as a stand-alone software package, partly on the user’s computer and partly on a remote computer or entirely on the remote computer. In the latter scenario, the remote computer may be connected to the user’s computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| Abbreviation | Explanation |
| BM | Beam management |
| CMR | Channel measurement restriction |
| CQI | Channel Quality Indicator |
| CRI | Channel resource indicator |
| CSI | Channel state information |
| CSI-RS | Channel state information reference symbol |
| DRX | Discontinuous reception |
| FR1 | Frequency range 1 |
| FR2 | Frequency range 2 |
| GNSS | Global navigation satellite system |
| IMR | Interference measurement restriction |
| L1-RSRP | Layer 1 reference signal received power |
| L1-SINR | Layer 1 signal to interference plus noise ratio |
| LI | Layer indicator |
| NZP-CSI-RS | Non-zero-power channel state information reference signal |
| PCell | Primary cell |
| PSCell | Primary SCG Cell |
| RI | Rank indicator |
| RSRP | Reference signal received power |
| RSRQ | Reference signal received quality |
| SCG | Secondary cell group |
| SNR | Signal to noise ratio |
| SpCell | Special cell |
| SSBRI | SS/PBCH block resource indicator |
| UE | User equipment |
| ZP-CSI-RS | Zero-power channel state information reference signal |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a wireless device, WD, the method comprising:
determining a number of samples for a Layer 1 signal-to-interference-plus-noise ratio, L1-SINR, measurement, the number of samples being based at least in part on at least one measurement restriction parameter;
determining a measurement period for the L1-SINR measurement based at least in part on the determined number of samples; and
performing the L1-SINR measurement on at least one channel measurement resource and at least one interference measurement resource, the L1-SINR measurement being based at least in part on the determined number of samples and the measurement period.

2. The method of claim 1, wherein determining the number of samples based at least in part on the at least one measurement restriction parameter comprises:
when the at least one measurement restriction parameter indicates a restriction on at least one of a channel measurement and an interference measurement, determining that the number of samples is 1.

3. The method of claim 1, wherein determining the number of samples based at least in part on the at least one measurement restriction parameter comprises:
when the at least one measurement restriction parameter indicates that there is a lack of a restriction on any of the channel measurement and the interference measurement, determining that the numbers of samples is greater than 1.

4. The method of claim 1, wherein determining the number of samples based at least in part on the at least one measurement restriction parameter comprises:
when the at least one measurement restriction parameter indicates that there is a lack of a restriction on any of the channel measurement and the interference measurement, determining that the numbers of samples is 3.

5. The method of claim 1, further comprising:
receiving a configuration including the at least one measurement restriction parameter.

6. The method of claim 1, wherein the at least one measurement restriction parameter comprises at least one of a time restriction for channel measurement and a time restriction for interference measurement.

7. The method of claim 6, wherein determining the number of samples based at least in part on the at least one measurement restriction parameter comprises:
when at least one of the channel measurement restriction and the interference measurement restriction is configured to the WD, determining that the number of samples is 1, otherwise;
determining that the numbers of samples is greater than 1.

8. The method of claim 1, wherein determining the measurement period for the L1-SINR measurement further comprises determining the measurement period as a function of at least one of:
the determined number of samples, a transmission period of the at least one channel measurement resource in time domain, a transmission period of the at least one interference measurement resource in time domain, an L1-SINR reporting period, and a scaling factor.

9. A method implemented in a network node configured to communicate with a wireless device, WD, the method comprising:
sending a configuration comprising at least one measurement restriction parameter to the WD, the at least one measurement restriction parameter associated with a Layer 1 signal-to-interference-plus-noise ratio, L1-SINR, measurement; and
receiving an L1-SINR report from the WD, the L1-SINR report being based at least in part on an L1 SINR measurement on at least one channel measurement resource and at least one interference measurement resource over a measurement period, the measurement period being based at least in part on a number of samples, the number of samples being based at least in part on the at least one measurement restriction parameter.

10. The method of claim 9, wherein when the at least one measurement restriction parameter indicates a restriction on at least one of a channel measurement and an interference measurement, the number of samples is 1.

11. The method of claim 9, wherein when the at least one measurement restriction parameter indicates that there is a lack of a restriction on any of the channel measurement and the interference measurement, the numbers of samples is 3.

12. The method of claim 9, wherein when the at least one measurement restriction parameter indicates that there is a lack of a restriction on any of the channel measurement and the interference measurement, the numbers of samples is greater than 1.

13. The method of claim 9, wherein the at least one measurement restriction parameter comprises at least one of a time restriction for channel measurement and a time restriction for interference measurement.

14. The method of claim 13, wherein:
when at least one of the channel measurement restriction and the interference measurement restriction is configured to the WD, the number of samples is 1, otherwise;
the numbers of samples is greater than 1.

15. The method of claim 9, wherein the measurement period for the L1-SINR measurement is a function of at least one of:
the number of samples, a transmission period of the at least one channel measurement resource in time domain, a transmission period of the at least one interference measurement resource in time domain, an L1-SINR reporting period, and a scaling factor.

16. A wireless device, WD, configured to communicate with a network node, the WD comprising processing circuitry, the processing circuitry configured to cause the WD to:
determine a number of samples for a Layer 1 signal-to-interference-plus-noise ratio, L1-SINR, measurement, the number of samples being based at least in part on at least one measurement restriction parameter;
determine a measurement period for the L1-SINR measurement based at least in part on the determined number of samples; and
perform the L1-SINR measurement on at least one channel measurement resource and at least one interference measurement resource, the L1-SINR measurement being based at least in part on the determined number of samples and the measurement period.

17. The WD of claim 16, wherein the processing circuitry is configured to cause the WD to determine the number of samples by being configured to:
when the at least one measurement restriction parameter indicates a restriction on at least one of a channel measurement and an interference measurement, determine that the number of samples is 1.

18. The WD of claim 16, wherein the processing circuitry is configured to cause the WD to determine the number of samples by being configured to:
when the at least one measurement restriction parameter indicates that there is a lack of a restriction on any of the channel measurement and the interference measurement, determine that the numbers of samples is greater than 1.

19. The WD of claim 16, wherein the processing circuitry is configured to cause the WD to determine the number of samples by being configured to:
when the at least one measurement restriction parameter indicates that there is a lack of a restriction on any of the channel measurement and the interference measurement, determine that the numbers of samples is 3.

20. The WD of claim 16, wherein the processing circuitry is further configured to cause the WD to:
receive a configuration including the at least one measurement restriction parameter.

21. The WD of claim 16, wherein the at least one measurement restriction parameter comprises at least one of a time restriction for channel measurement and a time restriction for interference measurement.

22. The WD of claim 21, wherein the processing circuitry is further configured to cause the WD to:
when at least one of the channel measurement restriction and the interference measurement restriction is configured to the WD, determine that the number of samples is 1, otherwise;
determine that the numbers of samples is greater than 1.

23. The WD of claim 16, wherein the processing circuitry is configured to cause the WD to determine the measurement period by being configured to cause the WD to:
determine the measurement period for the L1-SINR measurement as a function of at least one of:
the determined number of samples, a transmission period of the at least one channel measurement resource in time domain, a transmission period of the at least one interference measurement resource in time domain, an L1-SINR reporting period, and a scaling factor.

24. A network node configured to communicate with a wireless device, WD, the network node comprising processing circuitry, the processing circuitry configured to cause the network node to:
send a configuration comprising at least one measurement restriction parameter to the WD, the at least one measurement restriction parameter associated with a Layer 1 signal-to-interference-plus-noise ratio, L1-SINR, measurement; and
receive an L1-SINR report from the WD, the L1-SINR report being based at least in part on an L1 SINR measurement on at least one channel measurement resource and at least one interference measurement resource over a measurement period, the measurement period being based at least in part on a number of samples, the number of samples being based at least in part on the at least one measurement restriction parameter.

25. The network node of claim 24, wherein when the at least one measurement restriction parameter indicates a restriction on at least one of a channel measurement and an interference measurement, the number of samples is 1.

26. The network node of claim 24, wherein when the at least one measurement restriction parameter indicates that there is a lack of a restriction on any of the channel measurement and the interference measurement, the numbers of samples is 3.

27-32. (canceled)
